(19) United States
(12) Patent Application Publication
(10) Pub. No.: US 2015/0350154 A1
(43) Pub. Date: Dec. 3, 2015

(54) Using Distributed Network Elements to Send Authoritative DNS Responses

(71) Applicants: John Myla, Santa Clara, CA (US); Srinivasa R. Addepalli, San Jose, CA (US)

(72) Inventors: John Myla, Santa Clara, CA (US); Srinivasa R. Addepalli, San Jose, CA (US)

(21) Appl. No.: 14/294,298

(22) Filed: Jun. 3, 2014

(51) Int. Cl. H04L 29/12; H04L 29/08

(52) U.S. Cl. CPC H04L 61/1511; H04L 61/103; H04L 67/10

(57) ABSTRACT

This disclosure describes a network element controller that communicates with a bank of network elements over a software defined network (SDN) to provide DNS responds to external users. The network elements, such as switches and routers, reside within a computer perimeter network or data center and intercept DNS requests from resolving DNS servers that are destined for an authoritative name server. The network elements, in turn, send a DNS response to the resolving DNS servers on behalf of the authoritative name server, which include a corresponding DNS record and a source address of the authoritative name server. In one embodiment, the network element controller proactively programs DNS records on each of the network elements included in the perimeter network.

### TECHNICAL FIELD

The present disclosure relates to using distributed network elements to send authoritative Domain Name System (DNS) responses transparently to resolving DNS servers.

### BACKGROUND

A Domain Name System (DNS) is a hierarchical distributed naming system for computers, services, and other resources connected to the Internet or a private computer network. The DNS allows a user to reference a resource by a human-friendly name, which the DNS translates into numerical IP addresses required by computer networks. The Domain Name System is an essential component of the functionality of the Internet. For example, the domain name www.companyabc.com may translate to an IPv4 address of 98.126.210.149 or an IPv6 address of 2001:4160:4872::8548.

The Domain Name System distributes the responsibility of assigning domain names and mapping the domain names to IP addresses to “authoritative name servers” for each domain. Authoritative name servers provide DNS resolutions for their respective namespace, or “zone.” For example, company ABC may employ an authoritative name server to provide translations for the zone “www.companyabc.com.”

Authoritative name servers are responsible for resolving client DNS queries from both internal networks and external networks. External network serving authoritative name servers, or public authoritative name servers, are located in a data center or an enterprise's perimeter network. A perimeter network is a physical or logical subnetwork that contains and exposes an organization's external-facing services to a larger and untrusted network. The purpose of a perimeter network is to add an additional layer of security to an organization's local area network (LAN) such that an external attacker only has direct access to equipment in the perimeter network rather than any other part of the network.

When a user enters a human readable address in a client's browser window, the client must translate the human readable address to a computer readable address, such as an IPv4 address or an IPv6 address discussed above. The client checks a local cache for a corresponding DNS record and, if the DNS record is found, the client uses the DNS record to translate the human-readable address to a computer readable address and loads a page of data corresponding to the computer readable address. However, when the client does not have a DNS record in its local cache, the client sends a DNS request to the client's resolving DNS server, which increases the amount of time for the client to load the page of data for the user to view. This increased amount of time is referred to DNS latency.

DNS latency may result in an insignificant amount of time when the resolving DNS server has the requested DNS record in local memory and provides the DNS record to the client. However, DNS latency may increase substantially if the resolving DNS server does not have the requested DNS record stored in local memory and, therefore, is required to request the DNS record from the appropriate authoritative name server. Since the client requires the DNS record to translate the human readable address into a computer readable address and load the corresponding page of data, the client's user may become frustrated with increased page loading times due to increased DNS latency time. In addition, DNS latency times may further increase during authoritative name server outages due to, for example, equipment malfunctions, power outages, or malicious users.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram depicting one example of a network element controller and network elements configured to transparently function as distributed authoritative name servers;

FIG. 2 is a diagram depicting one example of a high-level flowchart showing steps taken in a resolving DNS server obtaining a DNS record for a client request;

FIG. 3 is a diagram depicting one example of a flowchart showing steps taken in a network element intercepting a DNS request and providing a DNS response;

FIG. 4 is a diagram depicting one example of a network element controller proactively populating network elements with DNS records obtained from an authoritative name server;

FIG. 5 is a diagram depicting one example of a network element controller performing a centralized flush of DNS records stored in network elements;

FIG. 6 is a diagram depicting one example of a network element controller aggregating statistical information received from network elements;

FIG. 7 is a block diagram of a data processing system in which the methods described herein can be implemented; and

FIG. 8 provides an extension of the information handling system environment shown in FIG. 7 to illustrate that the methods described herein can be performed on a wide variety of information handling systems which operate in a networked environment.

### DETAILED DESCRIPTION

This disclosure describes a network element controller that communicates with a bank of network elements over a software defined network (SDN) framework using an OpenFlow protocol to provide DNS responses to external users. The network elements, such as switches and routers, reside within an enterprise's perimeter network or data center and intercept DNS requests from resolving DNS servers that are destined for an authoritative name server. The network elements, in turn, send a DNS response to the resolving DNS servers on behalf of the authoritative name server, which include a corresponding DNS record and a source address of the authoritative name server. As a result, high volume DNS requests are supported and response times are reduced due to the large number of network elements and resource availability.

In one embodiment, the network element controller proactively programs DNS records in the network elements. When a network element informs the network element controller of a request for an unavailable DNS record, the network element controller obtains the DNS record from either local storage or the authoritative name server and distributes the DNS record to each network element.

In another embodiment, the network element controller maintains centralized statistics and analytics. These statistics are used for rate limiting and other access controls at a granular level to avoid distributed denial of service (DDoS) attacks, such as identification of malicious DNS clients based on IP addresses. In yet another embodiment, the network element controller performs a centralized flush of all expired/invalid DNS records and a reprogramming of DNS records in individual network elements during situations, such as zone changes, to avoid zone transfers and record updates by the network elements.

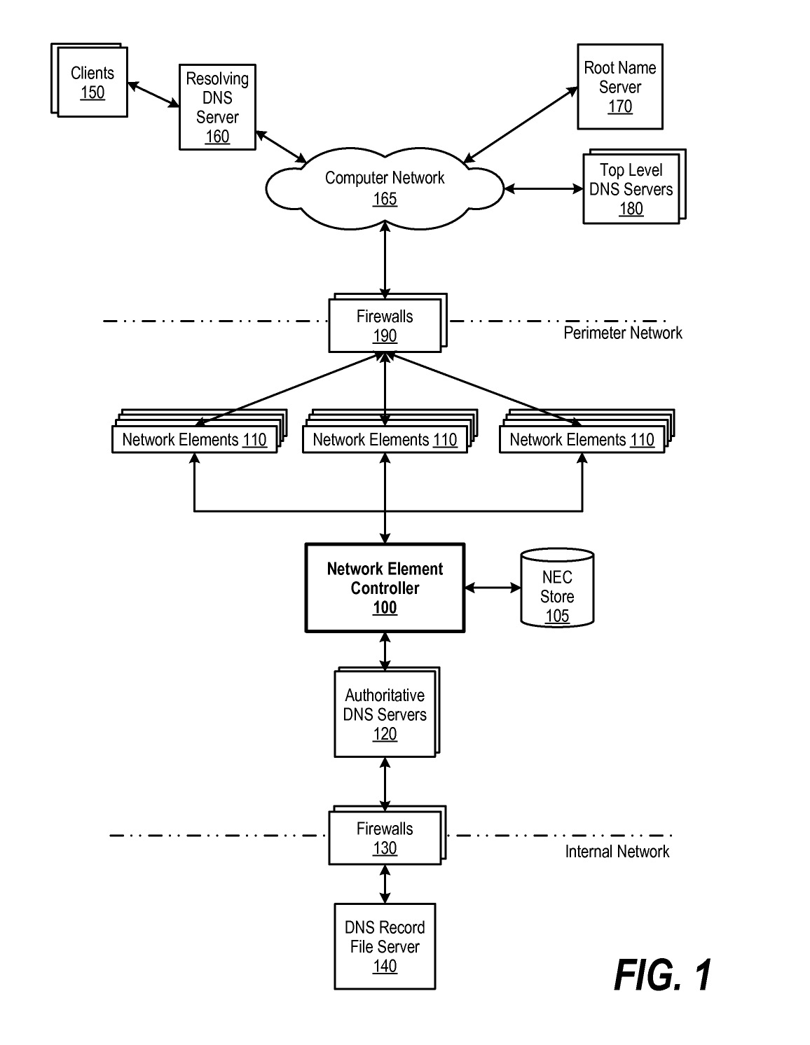

FIG. 1 is a diagram depicting one example of a network element controller and network elements configured to transparently function as a distributed authoritative name server. Network element controller 100 resides in a perimeter network and provides a separation between computer network 165, such as the Internet, and a company's internal network. DNS record file server 140 resides in the internal network, and includes DNS records of classname mapping information. DNS record file server 140 provides the DNS records to authoritative name servers 120 through firewalls 130, which separate the internal network from the perimeter network. Network element controller 100, in turn, obtains the DNS records from authoritative name servers 120 and distributes the DNS records to network elements 110. Network elements 110 may include, for example, switches and routers that are currently installed as part of a network infrastructure residing in the perimeter network. In turn, as discussed in more detail below, network elements 110 respond to DNS requests targeted for authoritative name server 120 and provide corresponding DNS records to external computer network entities without the external computer network entities knowing of the existence of network elements 110. In one embodiment, network elements 110 utilize a DNS record interception tool that executes a set of program instructions to perform functions discussed herein.

When a remote client 150 requires a DNS address translation, such as in response to client 150's user entering “www.companyabc.com/info” in a browser window, client 150 sends a DNS request to resolving DNS server 160. Resolving DNS server 160 may be a preferred DNS server that supports client 150. If resolving DNS server 160 does not have a matching DNS record in local storage, resolving DNS server 160 sends a request to root name server 170 through computer network 165. Root name server 170 knows the addresses of top level DNS servers 180, which are DNS servers that manage top level domains such as a “*.com” domain, a “*.org” domain, a “*.edu” or a “.net” domain.

Root name server 170 provides the top level DNS server address to resolving DNS server 160 corresponding to resolving DNS server 160's request. Using the example above, since the user's entered address has a “.com” root, the root name server response includes an address for a top level DNS server that supports the “.com” domain. Top level DNS servers 180 include “corporate level” DNS records, such as the DNS record of company ABC's authoritative name server. Resolving DNS server 160, in turn, sends a request to one of top level DNS servers 180 to obtain an address for an authoritative name server corresponding to the user's entry of “www.companyabc.com.”

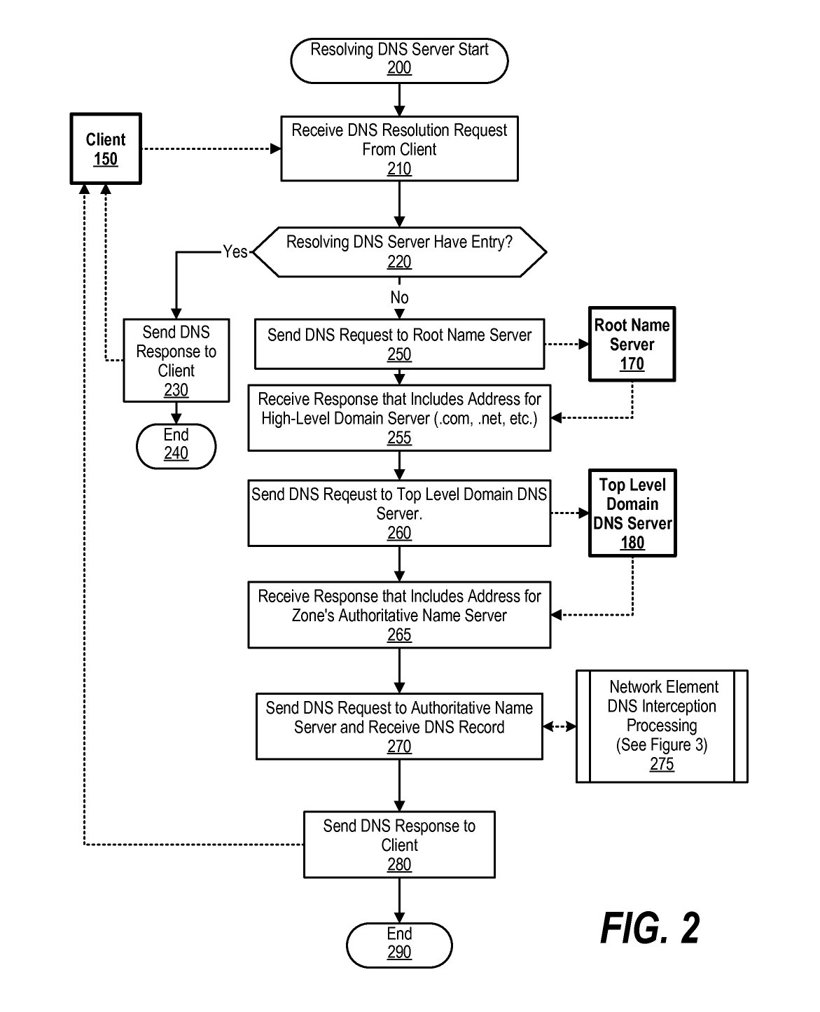

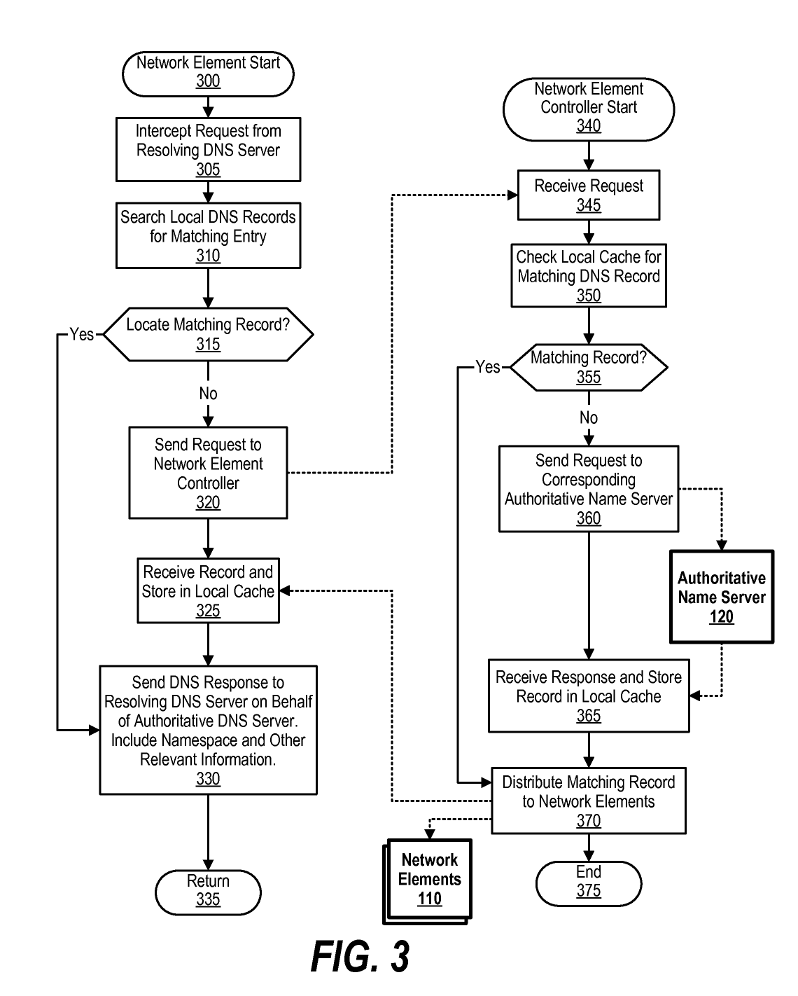

The top level DNS server 180 provides the address of authoritative name server 120 to resolving DNS server 160. Resolving DNS server 160, in turn, sends a DNS request to authoritative name server 120 through computer network 165. The DNS request traverses through firewalls 190 that, in one embodiment, establish the external boundary of the perimeter network between computer network 165 and the company's domain. One of network elements 110 intercepts the DNS request by detecting, for example, that the destination address in the DNS request corresponds to authoritative name server 120. Since network element controller 100 previously populated network elements 110 with DNS records, network element 110 checks a local cache for a matching DNS record and, if found, provides the DNS record to resolving DNS server 160 in a DNS response. The DNS response includes authoritative name server 120's address as a source address because network element 110 acts on behalf of authoritative name server 120 and is transparent to computer network 165 (see FIGS. 2, 3, and corresponding text for further details).

When network element 110 does not include a matching DNS record in local cache, network element 110 informs network element controller 100. Network element controller 100 checks network element controller store 105 for the matching DNS record. If network element controller 100 locates the DNS record in network element controller store 105, network element controller 100 distributes the DNS record to all of network elements 110, which each of network elements 110 store in their local caches.

If network element controller store 105 does not include the DNS record, network element controller 100 sends a request to authoritative name server 120. Authoritative name server 120 provides the DNS record to network element controller 100, which network element controller 100 stores in network element controller store 105 and distributes to all of network elements 110, which each of network elements 110 store in their local caches (see FIGS. 2, 3, and corresponding text for further details).

FIG. 2 is a diagram depicting one example of a high-level flowchart showing steps taken in a resolving DNS server obtaining a DNS record for a client request. Processing commences at 200, whereupon the resolving DNS server receives a request from client 150 at 210. For example, client 150's user may enter “www.companyabc.com/info” in a browser window and the client may not have a local DNS translation entry of company ABC.

A determination is made as to whether the resolving DNS server has a matching DNS record in a local storage area (decision 220). If the resolving DNS server located a matching record, decision 220 branches to the “Yes” branch, whereupon the resolving DNS server sends a DNS response to client 150 at 230 that includes the DNS record corresponding to the DNS request, and processing ends at 240.

On the other hand, if the resolving DNS server does not locate a matching DNS record, decision 220 branches to the “No” branch, whereupon the resolving DNS server sends a request to root name server 170 (250) to request a corresponding top level domain DNS server address. If the resolving DNS server knows the address of the corresponding top level DNS server, 250 is bypassed. The resolving DNS server receives a response from root name server 170 at 255 that includes a top level domain DNS server address. For example, since the entry has a “.com” root, the root name server response includes an address for a top level DNS server that supports the “.com” domain.

At 260, the resolving DNS server sends a request to top level domain DNS server 180 to obtain an address for an authoritative name server that supports the company “ABC's” domain. If the resolving DNS server knows the address of the corresponding authoritative name server, 260 is bypassed. The local server receives the authoritative name server address from top level DNS server 180 at 265. In turn, the resolving DNS server sends a DNS request to the corresponding authoritative name server at 270. When the resolving DNS server sends the DNS request to the authoritative name server, a network element intercepts the request and provides the DNS record back to the resolving DNS server on behalf of the authoritative name server (pre-defined process block 275, see FIG. 3 and corresponding text for further details). The resolving DNS server, in turn, forwards the DNS record to client 150 at 280. Processing ends at 290.

FIG. 3 is a diagram depicting one example of a flowchart showing steps taken in a network element intercepting a DNS request and providing a DNS response to a resolving DNS server. Processing commences at 300, whereupon the network element intercepts a DNS request from a resolving DNS server with a destination of the authoritative name server (305). In one embodiment, the intercepting network element is transparent to the resolving DNS server. In this embodiment, the DNS request does not include an address of the intercepting network element, but rather includes a destination address of an authoritative name server.

At 310, the network element searches in a local cache for a matching DNS record, and a determination is made as to whether the local cache includes a matching record (decision 315). If the network element's local cache includes a matching record, decision 315 branches to the “Yes” branch, whereupon the network element sends a DNS response to the resolving DNS server on behalf of the authoritative name server (330) and processing ends at 335. In one embodiment, the DNS response includes the following information:
Source Address: Authoritative name server IP and port
Destination Address: DNS Client IP and port
Query: Translation ID, Flags, Number of Questions, Number of Answers, Query domain Name, Query type, Query class
Answer: Domain name, query type, query class, address

As can be seen from the above embodiment, the network element inserts the authoritative name server's IP address and port in the response because the network element is sending the DNS response on behalf of the authoritative name server.

On the other hand, if the network element's local cache does not include a matching record, decision 315 branches to the “No” branch, whereupon the network element sends a request to the network element controller at 320. In one embodiment, the DNS request to the network element controller includes the following information:
Source Address: Network Element IP and port
Destination Address: Network Element Controller IP and port
DNS entry miss with table ID and PKT In, DNS Client IP, Port (source), Authoritative name server IP, Port (destination)
Query: Translation ID, Flags, Number of Questions, Number of Answers, Query domain name, query type, query class

Network element controller processing commences at 340, whereupon the network element controller receives the request from the network element at 345. At 350, the network element controller checks network element controller store 105 for a matching DNS record. A determination is made as to whether the network element controller located a matching record (decision 355). If the network element controller located the matching record, decision 355 branches to the “Yes” branch, whereupon the network element controller distributes the matching record to the requesting network element as well as each of network elements 110 shown in FIG. 1 (370). In one embodiment, the DNS response includes the following information:
Source Address: Network Element Controller IP and port
Destination Address: Network Element IP and port
Flow mod add entry with entry life timeout, {domain name, query type, query class, address}

On the other hand, if the network element controller did not locate a matching record, decision 355 branches to the “No” branch, whereupon the network element controller sends a request to authoritative name server 120 at 360. In one embodiment, the request to authoritative name server 120 includes the following information:
Source Address: Network Element Controller IP and port
Destination Address: Authoritative name server IP and port
Query: Translation ID, Flags, Number of Questions, Number of Answers, Query domain Name, Query type, Query class

The network element controller receives a response from authoritative name server 120 at 365 that includes a matching DNS record, whereupon the network element controller stores the matching record in network element controller store 105. In one embodiment, the DNS response from authoritative name server 120 includes the following information:
Source Address: Authoritative name server IP and port
Destination Address: Network Element Controller IP and port
Query: Translation ID, Flags, Number of Questions, Number of Answers, Query domain Name, Query type, Query class
Answer: Domain name, query type, query class, address

At 370, the network element controller distributes the matching record to the requesting network element as well as each of other network elements 110 (370), and network element controller processing ends at 375. In one embodiment, the message to the network elements from the network element controller includes the following information:
Source Address: Network Element Controller IP and port
Destination Address: Network Element IP and port
DNS Record Add {domain name, query type, query class, address}

Referring back to network element processing, the network element receives the matching record at 325 and stores the matching record in local cache for subsequent DNS requests. In one embodiment, the network element stores the DNS record, which includes a Domain name, Query type, Query class, address, time to live (TTL), and a network element entry lifetime. In this embodiment, the network element entry lifetime is a validity period of the record at the network element. When the lifetime expires, the network element removes the DNS record entry from the network element's cache. The network element entry lifetime is different from the DNS record's TTL, which is the validity period of a DNS record.

At 330, the network element sends a DNS response to the resolving DNS server on behalf of the authoritative name server, which includes namespace translation information and the authoritative name server's address information as discussed above. Processing returns at 335.

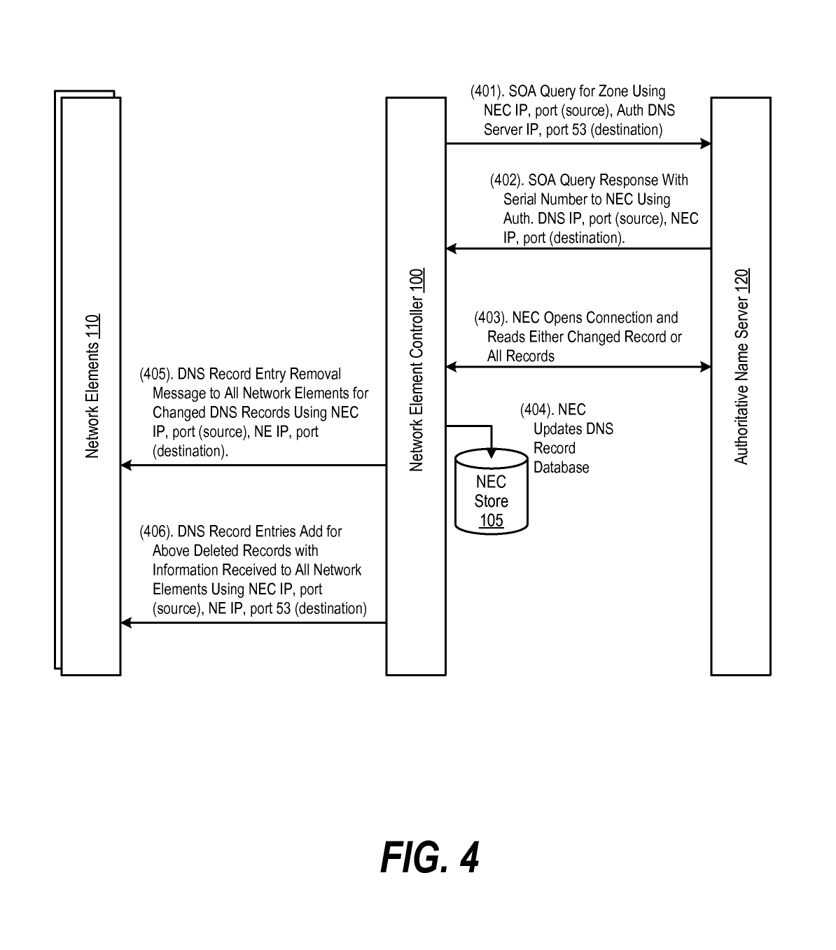

FIG. 4 is a diagram depicting one example of a network element controller proactively populating network elements with DNS records obtained from an authoritative name server. Network element controller 100 sends a start of authority (SOA) query for the zone (e.g., company domain) to authoritative name server 120 that includes the network element controller IP address and port, and the authoritative name server IP address and port (401).

Authoritative name server 120 sends an SOA query response to network element controller 100 that includes a serial number of the zone, the authoritative name server IP address and port as a source address, and the network element controller IP address and port as a destination address (402). In turn, network element controller 100 opens a connection with authoritative name server 120 and reads all DNS records or changed DNS records from last synchronization (403) according to record retrieval parameters. In one embodiment, network element controller 100 matches a sequence number included in the SOA query response with an existing sequence number that network element controller 100 received in a previous response. In this embodiment, network element controller 100 reads DNS records from authoritative name server 120 corresponding to unmatched sequence numbers. Network element controller 100 stores the received DNS records in network element controller store 105 (404).

In addition, network element controller 100 sends a record entry removal message to all network elements 110 for changed DNS records, which includes the network element controller IP address and port as a source address, each network element IP address and port as a destination address (405). In one embodiment, network element controller 100 uses software defined network protocols such as OpenFlow to send the DNS record removal message. Network element controller 100 then sends a DNS record entry add that includes the DNS records recently obtained from authoritative name server 120 (406).

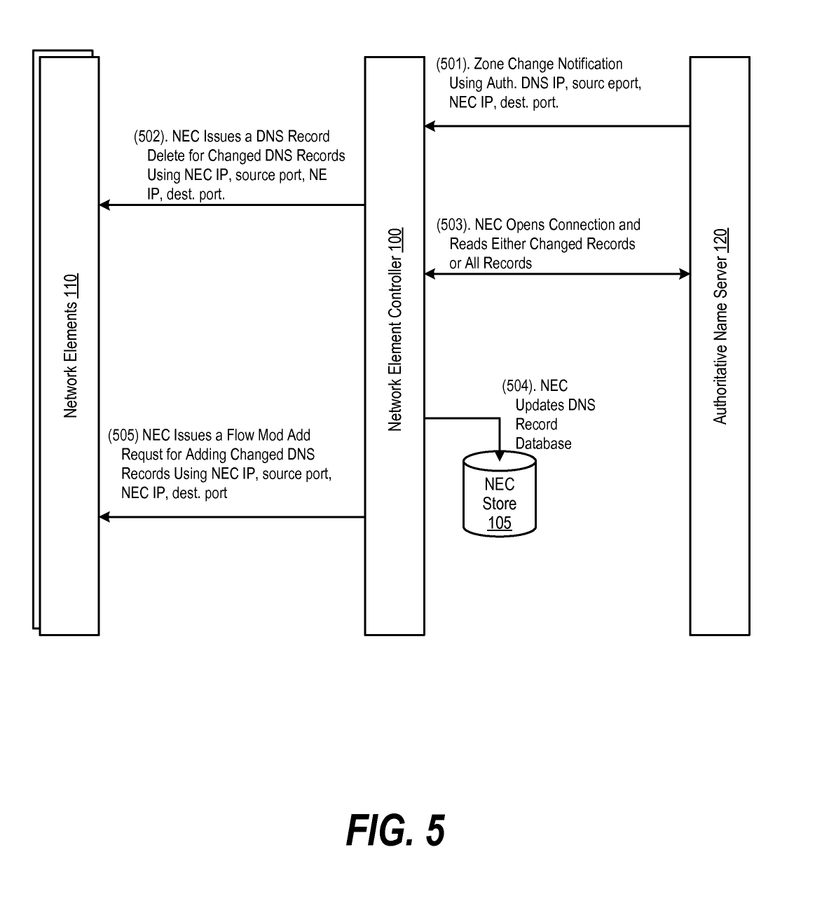

FIG. 5 is a diagram depicting one example of a network element controller performing a centralized flush of DNS records stored in network elements, such as during an authoritative name server zone change that requires the network element controller to replace all invalid/expired DNS records in the network elements with updated DNS records. For example, assume that company ABC's DNS mapping is 192.168.10.100 and the DNS records distributed to the network elements have a TTL (Time to Live) of two days. When company ABC wants to change its mapping to a different IP address before the TTL expires for security reasons, such as to 192.168.20.100, the DNS records in the network elements need to be removed and replaced.

Authoritative name server 120 sends a zone change notification to network element controller 100 (501). In turn, network element controller 100 issues a DNS record delete command to network elements 110 for changed DNS records (502). For example, the IP address mapping of a domain name may change prior to the TTL expiration of a DNS record. In this example, the DNS record is valid but does not include correct information and, therefore, network element controller 100 sends a message to all network elements to delete an existing DNS record and sends an entry add message with new DNS record.

Next, network element controller 100 opens a connection with authoritative name server 120 and obtains either changed records or all records (503). Network element controller 100 updates the DNS records in network element controller store 105 with the newly obtained DNS records (504). In turn, network element controller 100 issues a flow mod add request to network elements 110 to add changed DNS records to network elements 110's local cache (505). In one embodiment, network element controller 100 uses a software defined network protocol such as OpenFlow to send the DNS message to the network elements.

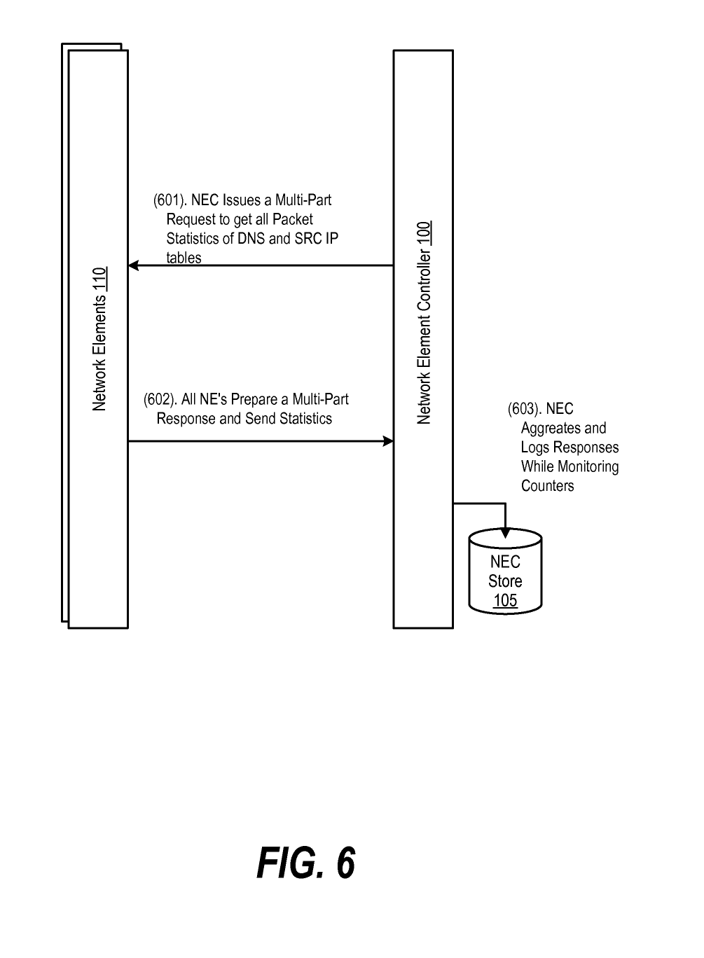

FIG. 6 is a diagram depicting one example of a network element controller aggregating statistical information from network elements. Network element controller 100 issues a multipart request to network elements 110, requesting each network element 110 to send packet statistics of DNS and source IP tables to network element controller 100 (601).

Each of network elements 110 prepare a multi-part response and send their corresponding statistical data to network element controller 100 such as the number of intercepted DNS queries, the number of DNS cache missies, the number of requests from a DMS client, the number of requests made to network element controller 100, etc. (602).

In turn, network element controller 100 aggregates the statistics in network element controller store 105 and monitors statistical counters accordingly (603). For example, to identify a rogue DNS client, network element controller 100 may monitor requests from the client and instill a threshold on the client requests to avoid resource misuse by the rogue client.

According to one embodiment of the present disclosure, a network element intercepts a DNS request initiated by a resolving DNS server and intended for an authoritative name server. The network element locates a DNS record that corresponds to the DNS request and includes a computer readable address corresponding to a domain name included in the DNS request. In turn, the network element sends a DNS response to the resolving DNS server over a computer network that includes the DNS record and the address of the authoritative name server.

According to yet another embodiment of the present disclosure, the network element receives a first set of DNS records from a network element controller, and stores the first set of DNS records in a network element local storage area. In this embodiment, the network element searches the first set of DNS records to locate the DNS record.

According to yet another embodiment of the present disclosure, the network element sends a request to the network element controller in response to determining that the DNS record is not located in the first set of DNS records. The network element, in turn, receives the DNS record from the network element controller, stores the DNS record in the network element local storage area, and sends the received DNS record to the resolving DNS server.

According to yet another embodiment of the present disclosure, the network element receives a record delete request from the network element controller corresponding to a zone change of the authoritative name server. The network element, in turn, replaces the first set of DNS records with a second set of DNS records in the network element local storage area.

According to yet another embodiment of the present disclosure, the network element receives a request from the network element controller to provide statistical data to the network element controller. The network element collects the statistical data and sends the collected statistical data to the network element controller.

According to yet another embodiment of the present disclosure, the network element communicates with the network element controller using a software defined network protocol.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, a software embodiment (including firmware, resident software, micro-code, etc.), including processing circuitry for executing thereof, or an embodiment combining software and hardware aspects that may all generally be referred to herein as a “circuit,” “module” or “system.”

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

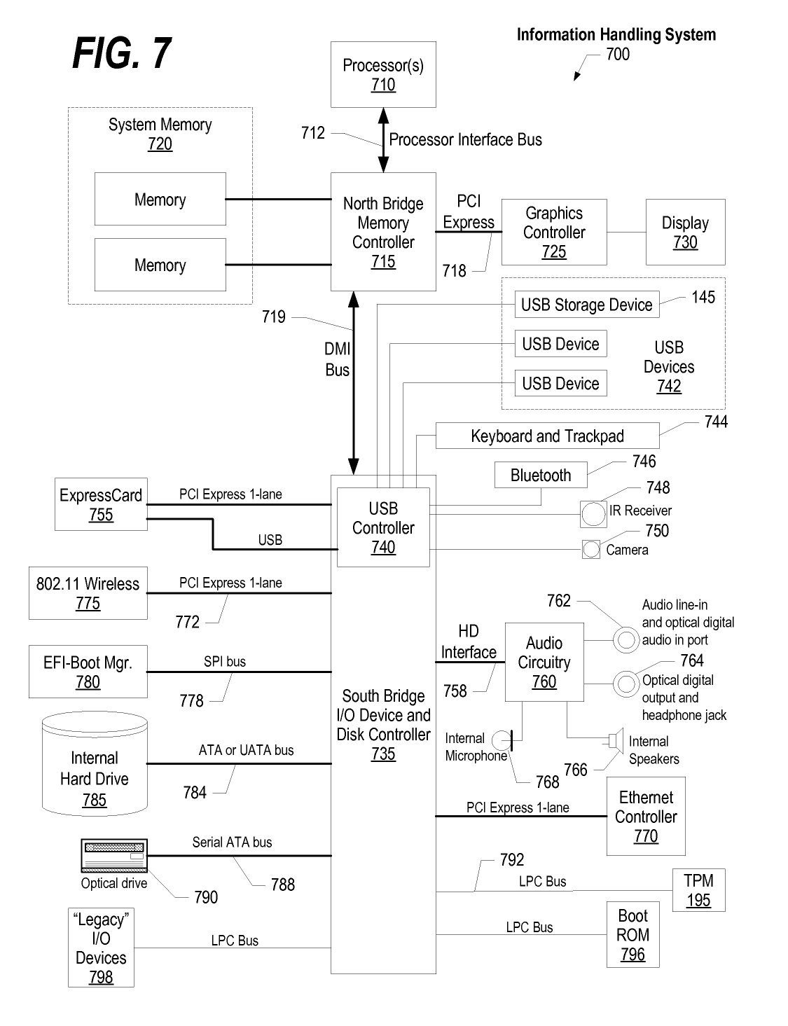

FIG. 7 illustrates information handling system 700, which is a simplified example of a computer system capable of performing the computing operations described herein. Information handling system 700 includes one or more processors 710 coupled to processor interface bus 712. Processor interface bus 712 connects processors 710 to Northbridge 715, which is also known as the Memory Controller Hub (MCH). Northbridge 715 connects to system memory 720 and provides a means for processor(s) 710 to access the system memory. Graphics controller 725 also connects to Northbridge 715. In one embodiment, PCI Express bus 718 connects Northbridge 715 to graphics controller 725. Graphics controller 725 connects to display device 730, such as a computer monitor.

Northbridge 715 and Southbridge 735 connect to each other using bus 719. In one embodiment, the bus is a Direct Media Interface (DMI) bus that transfers data at high speeds in each direction between Northbridge 715 and Southbridge 735. In another embodiment, a Peripheral Component Interconnect (PCI) bus connects the Northbridge and the Southbridge. Southbridge 735, also known as the I/O Controller Hub (ICH) is a chip that generally implements capabilities that operate at slower speeds than the capabilities provided by the Northbridge. Southbridge 735 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 796 and “legacy” I/O devices (using a “super I/O” chip). The “legacy” I/O devices (798) can include, for example, serial and parallel ports, keyboard, mouse, and/or a floppy disk controller. The LPC bus also connects Southbridge 735 to Trusted Platform Module (TPM) 795. Other components often included in Southbridge 735 include a Direct Memory Access (DMA) controller, a Programmable Interrupt Controller (PIC), and a storage device controller, which connects Southbridge 735 to nonvolatile storage device 785, such as a hard disk drive, using bus 784.

ExpressCard 755 is a slot that connects hot-pluggable devices to the information handling system. ExpressCard 755 supports both PCI Express and USB connectivity as it connects to Southbridge 735 using both the Universal Serial Bus (USB) the PCI Express bus. Southbridge 735 includes USB Controller 740 that provides USB connectivity to devices that connect to the USB. These devices include webcam (camera) 750, infrared (IR) receiver 748, keyboard and trackpad 744, and Bluetooth device 746, which provides for wireless personal area networks (PANs). USB Controller 740 also provides USB connectivity to other miscellaneous USB connected devices 742, such as a mouse, removable nonvolatile storage device 745, modems, network cards, ISDN connectors, fax, printers, USB hubs, and many other types of USB connected devices. While removable nonvolatile storage device 745 is shown as a USB-connected device, removable nonvolatile storage device 745 could be connected using a different interface, such as a Firewire interface, etcetera.

Wireless Local Area Network (LAN) device 775 connects to Southbridge 735 via the PCI or PCI Express bus 772. LAN device 775 typically implements one of the IEEE 802.11 standards of over-the-air modulation techniques that all use the same protocol to wireless communicate between information handling system 700 and another computer system or device. Optical storage device 790 connects to Southbridge 735 using Serial ATA (SATA) bus 788. Serial ATA adapters and devices communicate over a high-speed serial link. The Serial ATA bus also connects Southbridge 735 to other forms of storage devices, such as hard disk drives. Audio circuitry 760, such as a sound card, connects to Southbridge 735 via bus 758. Audio circuitry 760 also provides functionality such as audio line-in and optical digital audio in port 762, optical digital output and headphone jack 764, internal speakers 766, and internal microphone 768. Ethernet controller 770 connects to Southbridge 735 using a bus, such as the PCI or PCI Express bus. Ethernet controller 770 connects information handling system 700 to a computer network, such as a Local Area Network (LAN), the Internet, and other public and private computer networks.

While FIG. 7 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

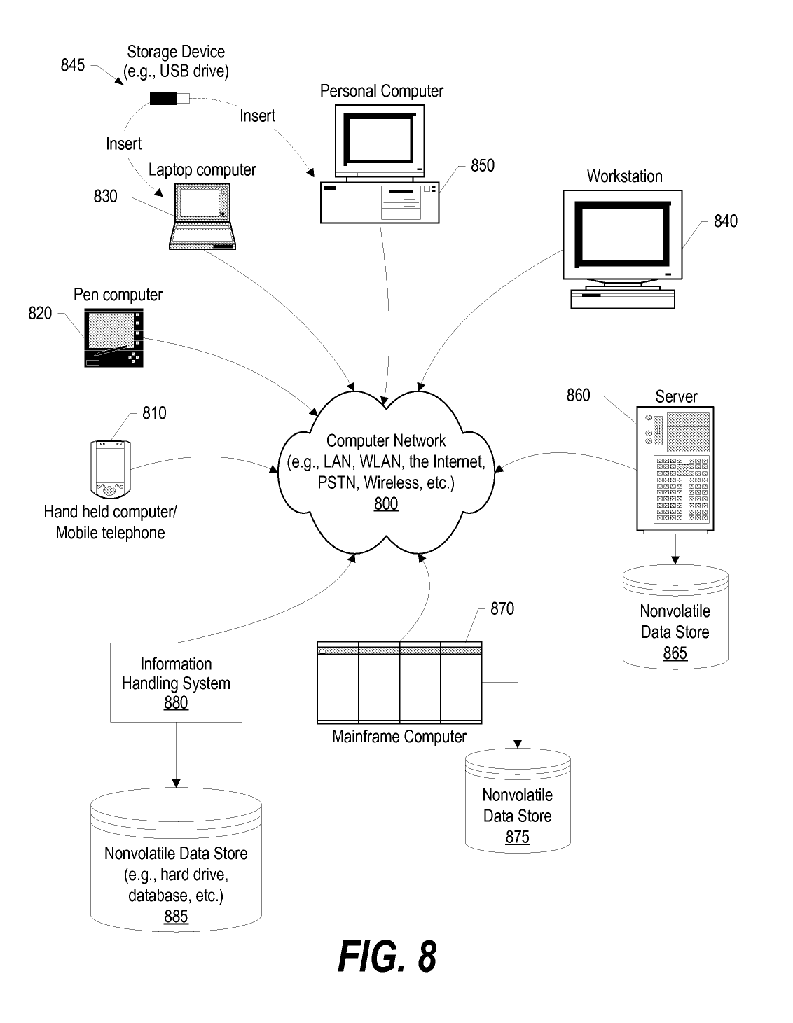

The Trusted Platform Module (TPM 795) shown in FIG. 7 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 8.

FIG. 8 provides an extension of the information handling system environment shown in FIG. 7 to illustrate that the methods described herein can be performed on a wide variety of information handling systems that operate in a networked environment. Types of information handling systems range from small handheld devices, such as handheld computer/mobile telephone 810 to large mainframe systems, such as mainframe computer 870. Examples of handheld computer 810 include personal digital assistants (PDAs), personal entertainment devices, such as MP3 players, portable televisions, and compact disc players. Other examples of information handling systems include pen, or tablet, computer 820, laptop, or notebook, computer 830, workstation 840, personal computer system 850, and server 860. Other types of information handling systems that are not individually shown in FIG. 8 are represented by information handling system 880. As shown, the various information handling systems can be networked together using computer network 800. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 8 depicts separate nonvolatile data stores (server 860 utilizes nonvolatile data store 865, mainframe computer 870 utilizes nonvolatile data store 875, and information handling system 880 utilizes nonvolatile data store 885). The nonvolatile data store can be a component that is external to the various information handling systems or can be internal to one of the information handling systems. In addition, removable nonvolatile storage device 745 can be shared among two or more information handling systems using various techniques, such as connecting the removable nonvolatile storage device 745 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method for sending domain name system (DNS) responses from a network element, the method comprising:
intercepting, at a network element, a DNS request to an authoritative name server, wherein the DNS request is initiated by a resolving DNS server and comprises a domain name and an address of the authoritative name server, and wherein the authoritative name server is different than the network element;
locating, by the network element, a DNS record that corresponds to the DNS request, wherein the DNS record comprises a computer readable address corresponding to the domain name; and
sending a DNS response from the network element to the resolving DNS server over a computer network, wherein the DNS response comprises the DNS record and the address of the authoritative name server.

2. The method of claim 1 further comprising:
receiving a first set of DNS records at the network element from a network element controller; and
storing the first set of DNS records in a network element local storage area, wherein the locating of the DNS record involves searching the first set of DNS records.

3. The method of claim 2 further comprising:
sending a request from the network element to the network element controller in response to determining that the DNS record is not located in the first set of DNS records;
receiving a response at the network element from the network element controller that comprises the DNS record;
storing the received DNS record in the network element local storage area; and
sending the received DNS record to the resolving DNS server.

4. The method of claim 2 further comprising:
receiving a record delete request at the network element from the network element controller, wherein the record delete request corresponds to a zone change of the authoritative name server;
receiving a second set of DNS records at the network element from the network element controller; and
replacing, by the network element, the first set of DNS records with the second set of DNS records in the network element local storage area.

5. The method of claim 2 further comprising:
receiving a request at the network element from the network element controller to provide statistical data to the network element controller;
collecting the statistical data at the network element; and
sending the collected statistical data from the network element to the network element controller.

6. The method of claim 2 wherein the network element communicates with the network element controller using a software defined network protocol.

7. The method of claim 1 wherein the network element is selected from the group consisting of a switch and a router.

8. A method for distributing domain name system (DNS) records to network elements, the method comprising:
receiving a first set of DNS records at a network element controller from an authoritative name server, wherein each of the DNS records comprises
a human readable address and a corresponding computer readable address;
storing, by the network element controller, the first set of DNS records in a network element controller storage area; and
distributing, by the network element controller, the first set of DNS records to each of a plurality of network elements.

9. The method of claim 8 wherein the network element controller communicates to the plurality of network elements using a software defined network protocol.

10. The method of claim 8 further comprising:
receiving, at the network element controller, a first request for a DNS record from a requesting one of the plurality of network elements;
determining, by the network element controller, whether the DNS record is located in the network element controller storage area; and
in response to locating the DNS record in the network element controller storage area, sending the located DNS record from the network element controller to the requesting network element.

11. The method of claim 10 further comprising:
distributing the located DNS record to each of the plurality of network elements.

12. The method of claim 10 further comprising:
sending, by the network element controller, a second request to the authoritative name server in response to determining that the DNS record is not located in the network element controller local storage area;
receiving the DNS record at the network element controller from the authoritative name server;
storing the received DNS record in the network element controller storage area; and
distributing the received DNS record from the network element controller to each of the plurality of network elements.

13. The method of claim 10 further comprising:
receiving a second set of DNS records at the network element controller from the authoritative name server in response to receiving a zone change notification from the authoritative name server;
sending a request from the network element controller to each of the plurality of network elements to delete the first set of DNS records; and
sending the second set of DNS records from the network element controller to each of the plurality of network elements.

14. The method of claim 8 further comprising:
sending a statistical data request from the network element controller to the plurality of network elements;
receiving statistical data at the network element controller from each of the plurality of network elements;
aggregating, by the network element controller, the received statistical data; and
storing the aggregated statistical data in the network element controller local storage area.

15. A system comprising:
one or more processors;
a memory accessible by the one or more processors;
a DNS record interception tool executed by at least one of the one or more processors and configured to:
intercept a DNS request to an authoritative name server, wherein the DNS request is initiated by a resolving DNS server and comprises a domain name and an address of the authoritative name server;
locating a DNS record that corresponds to the DNS request, wherein the DNS record comprises a computer readable address corresponding to the domain name; and
sending a DNS response to the resolving DNS server over a computer network, wherein the DNS response comprises the DNS record and the address of the authoritative name server.

16. The system of claim 15 wherein the DNS record interception tool is further configured to:
receive a first set of DNS records from a network element controller; and
store the first set of DNS records in the memory, wherein the locating of the DNS record involves searching the first set of DNS records.

17. The system of claim 16 wherein the DNS record interception is further configured to:
send a request to the network element controller in response to determining that the DNS record is not located in the first set of DNS records;
receive a response from the network element controller that comprises the DNS record;
store the received DNS record in the memory; and
send the received DNS record to the resolving DNS server.

18. The system of claim 16 wherein the DNS record interception tool is further configured to:
receive a record delete request from the network element controller, wherein the record delete request corresponds to a zone change of the authoritative name server;
receive a second set of DNS records from the network element controller; and
replace the first set of DNS records with the second set of DNS records in the memory.

19. The system of claim 16 wherein the DNS record interception tool is further configured to:
receive a request from the network element controller to provide statistical data to the network element controller;
collect the statistical data at the network element; and
send the collected statistical data to the network element controller.

20. The system of claim 16 wherein the system communicates with the network element controller using a software defined network protocol.
